(19) United States
(12) Patent Application Publication
(10) Pub. No.: US 2018/0050922 A1
(43) Pub. Date: Feb. 22, 2018

(54) PROCESS FOR PRODUCTION OF TITANIUM DIOXIDE (Ti02) NANOPARTICLES WITH DESIRED RATIO OF ANATASE AND RUTILE

(71) Applicants: Dr. Shanmugam SARAVANAN, Namakkal (D.T.) (IN); SONA COLLEGE OF TECHNOLOGY, Salem (IN)

(72) Inventor: DR. SHANMUGAM SARAVANAN, Namakkal (D.T.) (IN)

(21) Appl. No.: 15/128,992

(22) PCT Filed: Mar. 25, 2015
(86) PCT No.: PCT/IB2015/052192

§ 371 Date: Sep. 26, 2016

(30) Foreign Application Priority Data
Mar. 26, 2014 (IN) 1615/CHE/2014

(51) Int. Cl. C01G 23/053; C01G 23/08; C09C 1/36

(52) U.S. Cl. CPC C01G 23/0536; C01G 23/08; C09C 1/3692; C01P 2004/64; C01P 2002/70; C01P 2002/82; C01P 2002/52

(57) ABSTRACT

The present invention relates to a process for the production of titanium dioxide (TiO₂) nanoparticles with desired ratio of anatase phase and rutile phase, the method comprising (a) reacting titanium trichloride (TiCl₃) solution with a flower extract (b) drying the reaction mixture obtained in step (a) at high temperature to powder form and (c) calcination of the powder obtained in step (b) at high temperatures.

### FIELD OF THE INVENTION

The present invention relates to a process for producing titanium dioxide (TiO₂) nanoparticles with desired ratio of anatase and rutile phases. This method is a simple, cost effective and eco-friendly method, since it involves use of minimal chemicals and process steps. This process is useful to produce non doped and metal doped TiO₂ nanoparticles with high surface area which is suitable for high efficiency dye-sensitized solar cells (DSSC) applications and high photocatalytic activities.

### BACKGROUND OF THE INVENTION

Titanium dioxide (TiO₂) is of growing interest as it finds application in areas like paints and varnishes as well as paper and plastics. There are also other pigment applications like printing inks, fibers, rubber, cosmetic products and foodstuffs. TiO₂ photocatalysis is widely used in a variety of applications and products in the environmental and energy fields, including self-cleaning surfaces, air and water purification systems, sterilization, hydrogen evolution, and photoelectrochemical conversion. Additionally, it can be used as antibacterial agent because of strong oxidation activity and superhydrophilicity.

Titanium dioxide occurs in nature as two important polymorphs; the stable rutile and metastable anatase. Both phases are tetragonal in nature with different lattice parameters as shown in FIG. 1. These polymorphs exhibit different properties and consequently different photocatalytic performances.

In particular, nanocrystalline TiO₂ is well known as the most commonly used photoanode material for dye-sensitized solar cells (DSSC). The anatase phase (a-TiO₂) gained much attention due to its more active surface chemistry and smaller particles for more dye adsorption. Anatase is metastable and can be transformed irreversibly to thermodynamically more stable and condense rutile phase at higher temperature. The rutile phase TiO₂ (r-TiO₂), due to the high refractive index, has excellent light-scattering characteristics, which is a profitable property from the perspective of effective light harvesting. Combination of anatase and rutile TiO₂ can be more effective than the pure phase owing to the electron-holes separation at the interface between phases and the formation of interband gap trap which may influence interparticle carrier transportation.

US 2005/0164880 A1 describes a process for the preparation of a TiO₂ containing catalyst or catalyst support by sol-gel method which leads to catalysts or catalyst supports with TiO₂. The method for preparing the nano-crystalline TiO₂ has been reported in U.S. Pat. No. 7,638,555.

Good conversion efficiency was found to be achieved from the DSSCs based on TiO₂ nanocomposites with 24 wt % rutile nanorods, which was attributed to improved light harvesting caused by the enhancement of specific surface area and scattering effect from rutile nanorods (Wenquin Peng, Masatoshi Yanagida, Liyuan Han and Shahat Ahmed, Nanotechnology Vol. 22 (2011) 275709). As per Snejana Bakardjieva, Jan Subrt, Vaclav Stengl, Maria Jesus Dianez, Maria Jesus Sayagues, Applied Catalysis B, Environmental Vol. 58 (2005) 193-202), the photocatalytic activity of the sample containing 77.4% anatase and 22.6% rutile was higher than that of the nanocrystalline anatase powder.

In DSSC solar cell structures, mixing of 10 to 40 wt % of rutile with anatase is expected to increase the conversion efficiency due to high refractive index of rutile TiO₂. This is also expected to considerably reduce the cost involved in associated with the production the solar cells. However, fabrication of the composite structure consisting of TiO₂ nanoparticle matrix and scattering centers takes multiple processes, which include separate synthesis or acquisition of anatase TiO₂ nanoparticles and rutile TiO₂ nanoparticles and then mechanical mixing of the two forms. Such complex methods are not suitable for large-scale production. Moreover, the mechanical mixing can cause non-homogeneous distribution of scattering centers in TiO₂ matrix and also aggregation formation, which will lead to the presence of cracks in the film during sintering. With respect to the existing methods, there also exists another limitation of the rate of photocatalytic degradation which is attributed to the recombination of photogenerated electron-hole (e⁻-h⁺) pairs, which is also accounted to the non uniform size and clumping of the TiO₂ nano particles. There are no known processes for the production of TiO₂ with desired ratio of anantase and rutile.

Therefore there is a need for a simple and efficient process to produce TiO₂ nanoparticles which contains desired ratio of anatase and rutile with uniform particles, high surface area and minimum aggregation.

### SUMMARY OF THE INVENTION

It is an objective of the present invention to provide a simple and efficient process to produce TiO₂ which contains desired ratio of anatase and rutile nanoparticles with uniform particles, high surface area and minimum aggregation.

Accordingly In a primary aspect, the present invention relates to a process for the production of titanium dioxide (TiO₂) with desired ratio of anatase and rutile phase, the method comprising
(a) reacting titanium trichloride (TiCl₃) solution with a flower extract
(b) drying the reaction mixture obtained from step (a) at high temperature to powder form and
(c) calcination of the powder obtained in step (b) at high temperatures.

In a preferred embodiment, the process comprises doping TiO₂ nanoparticles with water soluble metal precursor. The water soluble metal precursor may be a water soluble precursor of metals selected from the group consisting of Ag, Ni, Zn, Cr, Ge, Mo, Ru, Rh, Sn, W, Sr, Al, Si, Mn, Fe, Au, Pt, Co, V, Cu and Pd.

Accordingly this invention also provides a process for the production of titanium dioxide (TiO₂) nanoparticles with desired ratio of anatase phase and rutile phase, the method comprising
(a) reacting titanium trichloride (TiCl₃) solution and a water soluble metal precursor with a flower extract
(b) drying the reaction mixture obtained from step (a) at high temperature to powder form and
(c) calcination of the powder obtained in step (b) at high temperatures.

Titanium trichloride (TiCl₃) used in the instant process may be an aqueous solution of 0.1% to 30% of TiCl₃ in double distilled de-ionized water.

In an important embodiment the present invention provides a solar cell comprising the mixed TiO₂ nanoparticles produced by the instant process. Accordingly the present invention provides dye sensitized solar cells (DSSCs) with anatase and rutile mixed TiO₂ resulted in high efficiency compared to 100% anatase.

Further scope and applicability of the present invention will become apparent from the detailed description given hereinafter. However, it should be understood that the detailed description and specific examples, while indicating embodiments of the invention, are given by way of illustration only, because various changes and modifications within the spirit and scope of the invention will become apparent to those skilled in the art from this detailed description. It is to be understood that both the foregoing general description and the following detailed description are exemplary and explanatory only and are not restrictive of the invention, as claimed.

### BRIEF DESCRIPTION OF THE DRAWINGS

The foregoing summary, as well as the following detailed description of the invention will be better understood when read in conjunction with the appended drawings. For the purpose of assisting in the explanation of the invention, there are shown in the drawings embodiments which are presently preferred and considered illustrative. It should be understood, however, that the invention is not limited to the precise arrangements and instrumentalities shown therein.

FIG. 1. Molecular structure of anatase and rutiles titanium dioxide.

FIG. 2. (a) & (b) X-ray diffraction pattern of TiO₂ nanoparticles prepared with different dosage of flower extract.

FIG. 3. X-ray diffraction pattern of 100% anatase annealed at different temperatures.

FIG. 4. Raman spectra of TiO₂ nanoparticles prepared with different dosage of flower extract.

FIG. 5. TEM images of TiO₂ nanoparticles prepared at different temperatures. a) 50° C.—5 ml b) 50° C.—40 ml c) 70° C.—40 ml d) 90° C.—40 ml of flower extract.

FIG. 6. High Resolution TEM image of (a) anatase TiO₂ and (b) rutile TiO₂ nanoparticle.

FIG. 7. TEM image of (a) Ag doped TiO₂ nanoparticles and (b) Ni doped TiO₂ nanoparticles. (c) SAED pattern of Ag-doped TiO₂ nanoparticles.

FIG. 8. HR-SEM image of the TiO₂ nanoparticle thin film on FTO coated glass substrate.

FIG. 9. EDX spectrum of (a) undoped TiO₂ (b) Ag doped TiO₂ and (c) Ni doped TiO₂ Nanoparticles.

FIG. 10. XPS analysis of (a) Ag doped and (b) Ni doped TiO₂

FIG. 11. Weight % of anatase vs volume of flower extract at room temperature and different high temperatures.

FIG. 12. FE-SEM image of anatase and rutile TiO₂ nanoparticles coated on FTO substrates.

FIG. 13. Absorption spectra of (a) A100 (b) 80 wt % of A100 and 20 wt % of R100 without and with dye loading.

FIG. 14. Reflection spectra of (a) A100 (b) 80 wt % of A100 and 20 wt % of R100 without and with dye loading.

FIG. 15. I-V cures of DSSCs fabricated from (a) A100 (b) 80 wt % of A100 and 20 wt % of R100 and (c) 80 wt % of A100 and 20 wt % of A42:R58 mixed TiO₂.

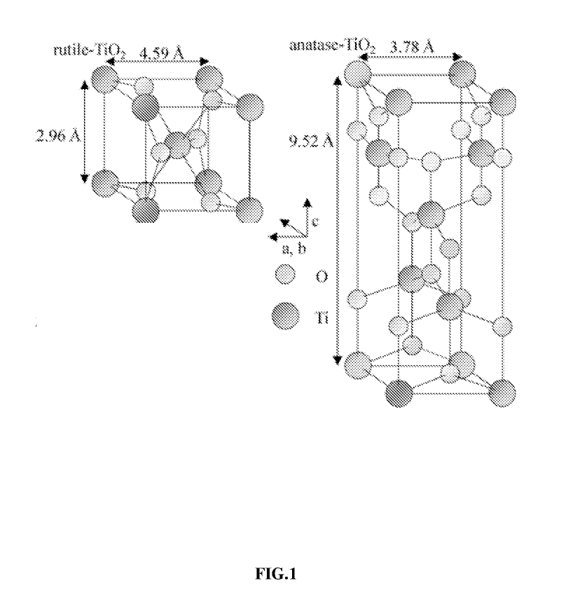

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification are to be understood as being modified in all instances by the term “about”. It is noted that, unless otherwise stated, all percentages given in this specification and appended claims refer to percentages by weight of the total composition. Thus, before describing the present invention in detail, it is to be understood that this invention is not limited to particularly exemplified systems or process parameters that may of course, vary. It is also to be understood that the terminology used herein is for the purpose of describing particular embodiments of the invention only, and is not intended to limit the scope of the invention in any manner.

The use of examples anywhere in this specification including examples of any terms discussed herein is illustrative only, and in no way limits the scope and meaning of the invention or of any exemplified term. Likewise, the invention is not limited to various embodiments given in this specification.

Unless otherwise defined, all technical and scientific terms used herein have the same meaning as commonly understood by one of ordinary skill in the art to which this invention pertains. In the case of conflict, the present document, including definitions will control.

It must be noted that, as used in this specification and the appended claims, the singular forms “a,” “an” and “the” include plural referents unless the content clearly dictates otherwise. Thus, for example, reference to “a flower extract” may include two or more such flower extracts.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “comprising” “including,” “having,” “containing,” “involving,” and the like are to be understood to be open-ended, i.e., to mean including but not limited to.

The term “nanopartcle” as herein described refers to ultrafine particles of TiO₂, which between 1 and 100 nanometers in size.

“Anantase” and “rutile” as used in the invention refers to the two mineral forms of titanium dioxide.

“Solar cell” (also called a photovoltaic cell) as herein described refers to is an electrical device that converts the energy of light directly into electricity by the photovoltaic effect. It is a form of photoelectric cell (in that its electrical characteristics e.g. current, voltage, or resistancevary when light is incident upon it) which, when exposed to light, can generate and support an electric current without being attached to any external voltage source, but do require an external load for power consumption.

The “fill factor”, as described herein is more commonly known by its abbreviation “FF”, of a solar cell refers to a parameter which, in conjunction with V_{oc} and I_{sc}, determines the maximum power from a solar cell. The FF is defined as the ratio of the maximum power from the solar cell to the product of V_{oc} and I_{sc}. Graphically, the FF is a measure of the “squareness” of the solar cell and is also the area of the largest rectangle which will fit in the IV curve.

“Calcination” (calcining) as herein described refers to a thermal treatment process in presence of air or oxygen applied to solid materials to bring about a thermal decomposition, phase transition, or removal of a volatile fraction. The calcination process normally takes place at temperatures below the melting point of the product materials.

“Annealing” as herein described refers to, a heat treatment in metallurgy that alters the microstructure of a material causing changes in properties such as strength, hardness, and ductility.

The present invention has been made in an effort to obtain TiO₂ which comprises desired ratio of anatase to rutile wherein a conversion of 100% anatase to 100% rutile or 100% rutile to 100% anatase is made possible. This is achieved by a process of reacting a flower extract with TiCl₃. The percentage conversion of anatase to rutile depends upon factors like the quantity of flower extract and the reaction temperature. Also, doping of different metals in TiO₂ is of additional advantage in that it provides TiO₂ nanoparticles with uniform particle size minimizing clumping and aggregation.

In the process of the present invention, the flower extract acts both as reducing and capping reagent in the preparation of TiO₂ from TiCl₃. In an important embodiment of the invention, the flower extract used in the process of the invention could be extract of flowers of plants selected from Peltophorum pterocarpum. However the present invention also could encompass the use of other flowers also for the process of the invention. The flower extract used in the instant process could be prepared by heating the flowers with double distilled deionized water at temperature ranging from 40° C. to 95° C. and filtering it.

TiO₂ shows relatively high reactivity and chemical stability under ultraviolet light (λ<387 nm), whose energy exceeds the band gap of 3.3 eV in the anatase crystalline phase. The absorption and photocatalytic activity of visible light will allow utilization of the main part of the solar spectrum, even under poor illumination of interior lighting. So, it is very essential to prepare visible light activated TiO₂ to improve the efficiency of the solar cells and photocatalytic activity. The metallic doping is expected to narrow the band gap of TiO₂.

Accordingly in an important embodiment of the present invention, the process of this invention includes doping metal ions into the TiO₂ lattice. TiO₂ may be doped with metallic dopants including the noble metal by adding the dopant precursor in step (a). Various metal dopants like Ag, Ni, Zn, Cr, Ge, Mo, Ru, Rh, Sn, W, Sr, Al, Si, Mn, Fe, Au, Pt, Co, V, Cu, Pd etc. can be doped by this technique. In a preferred embodiment the metal could be selected from Ag, Ni, Mn, Fe, Au, Pt, Co, V, Cu and Pd. Doping precursors are mixed at the stage of step (a); i.e., water soluble metal precursor and TiCl₃ are reacted with flower extract.

In an embodiment of the present invention, in step (a) diluted TiCl₃ and flower extract are mixed together. In the process of the invention, by the reaction of TiCl₃ and the flower extract, TiCl₃ is converted into Ti(OH)₄ and then TiO₂.

The reaction in step (a) of claim 1 is operated inside constant temperature bath at a temperature of 40° C. to 200° C., and in a more preferred aspect the temperature could be 50° C. to 90° C. The reaction is carried out with stirring at a speed of 5 to 100 rpm. In a preferred embodiment the stirring speed could be 20-40 rpm and in a more preferred aspect the stirring speed could be 30 rpm. The reaction in step a) could be carried out for a period (residence time) of 60-360 minutes. In a preferred embodiment, the residence time may be 120 to 180 min and in a more preferred aspect the residence time may be 120 min.

In an embodiment of the invention, the temperature of drying the solution in step (b) could be 40° C.-110° C.

In an embodiment of the invention, the temperature of calcinations in step (c) may be 300° C.-800° C. In a preferred embodiment, the temperature of calcination may be 400° C. to 650° C. and in a more preferred aspect the temperature of calcination may be 600° C. The duration of calcination in step (c) could be 60-300 min. In a preferred embodiment, the duration of calcination may be 150-210 min and in a more preferred aspect it may be 180 min.

The ratio of anatase to rutile in the TiO₂ obtained by this process could be 0:100 to 100:0 percentage by weight.

An important aspect of this invention provides a solar cell comprising the mixed (TiO₂) nanoparticles produced by the process of the instant invention. The solar cell as per the present invention may be a dye sensitized solar cell (DSSC). The fill factor of the DSSC may be prepared with mixed TiO₂. The TiO₂ nanoparticles are coated on conducting FTO (flourine doped tin oxide) substrate and dye sensitized solar cells (DSSCs) were fabricated with anatase and rutile mixed TiO₂. The dye sensitized solar cell (DSSC) as per the present invention exhibits high efficiency as compared to known solar cells which uses 100% anatase.

The green synthesized nanoparticles prepared by the present process are more stable even at high temperature up to 900° C. The prepared TiO₂ nanoparticles can be used in the fields of water purification, air purification, self cleaning surface, antibacterial agent, catalyitic activity, superhydrophilicity activity, conversion of solar energy into electrical energy, etc. Doping metal ions into the TiO₂ lattice reduces e⁻-h⁺ recombination in photocatalytic processes thereby helps to minimize aggregation and clumping of the TiO₂ nano particles and helps to obtain uniform nanoparticles with higher surface area, which is another important requirement for solar cell devices. The doping of metals in TiO₂ can also narrow the band gap and able to achieve visible light activated TiO₂. Visible light activated TiO₂ are expected to improve the efficiency of the solar cells and photocatalytic activity.

### Examples

### 1. Preparation of Plant Extract

Peltophorum pterocarpum flowers obtained from Salem, Tamilnadu, India, were used to prepare the flower extract. Peltophorum pterocarpum is a species of Peltophorum which belong to Family Fabaceae (Leguminosae), which is native to tropical southeastern Asia and a popularly ornamental tree grown around the world.

The fresh Peltophorum pterocarpum flowers were weighed and thoroughly washed several times by using double distilled deionized water to remove the adhering soil and dust. The washed flowers were boiled with double distilled deionized water at a temperature of 40° C. to 95° C. for about 3 minutes and then filtered. The extract was stored at 4° C. for further experiments.

### 2. Preparation of TiCl₃

The titanium trichloride (TiCl₃) was purchased from the market and prepared by mixing with the double distilled deionized water to make 0.1% to 30% aqueous solution of TiCl₃.

### 3. Synthesis of TiO₂ Nanoparticles

The Peltophorum pterocarpum flower extract was filled in a clean burette, and slowly dropped into 1.35% aqueous solution of TiCl₃ with constant stirring at 30 rpm at different temperatures ranging from 40° C. to 95° C. pH of the reaction mixture was about 1.5. The reaction mixture containing synthesized TiO₂ nanoparticles was dried by heating at around 60° C. Calcination of the powder was done at 600° C. for 3 hrs. Other components resulted from the process of this invention along with TiO₂ comprised of organic components such as carbon, titanium hydroxide and HCl. Carbon is expected to burn during the calcination of the powder around 600° C. Other by-products like titanium hydroxide and HCl will get evaporate during the drying and annealing process.

### 4. Synthesis of Metal Doped TiO₂ Nanoparticles

The Peltophorum pterocarpum flower extract was filled in a clean burette, and slowly dropped into 1.35% aqueous solution of TiCl₃ and a 1 to 20 wt. % of AgNO₃/NiCl₂.6H₂O with constant stirring at 30 rpm at different temperatures ranging from 40° C. to 95° C. pH of the reaction mixture was about 1.5. The reaction mixture containing synthesized TiO₂ nanoparticles was dried by heating at around 60° C. Calcination of the powder was done at 600° C. for 3 hrs. Other components resulted from the process of this invention along with TiO₂ comprised of organic components such as carbon, titanium hydroxide and HCl. Carbon is expected to burn during the calcination of the powder around 600° C. Other by-products like titanium hydroxide and HCl were expected to evaporate during the drying and annealing process.

### 5. Characterization

The influence of different parameters such as concentration of the base material, dosage of the flower extract, temperature and reaction time on the synthesis of TiO₂ nanoparticles were studied. The synthesized nanoparticles were characterized using X-Ray Diffraction (XRD), Raman spectroscopy, High Resolution Transmission Electron Microscopy (HR-TEM), High Resolution Scanning Electron Microscopy (HR-SEM), Electron Dispersive X-ray analysis (EDX), Electron Probe Micro-Analyzer (EPMA) and X-ray Photoelectron Spectroscopy (XPS) which reveal the formation TiO₂, nano nature of the particles and weight percentage of doping materials.

### 5.1 Powder X-Ray Diffraction (XRD) Study

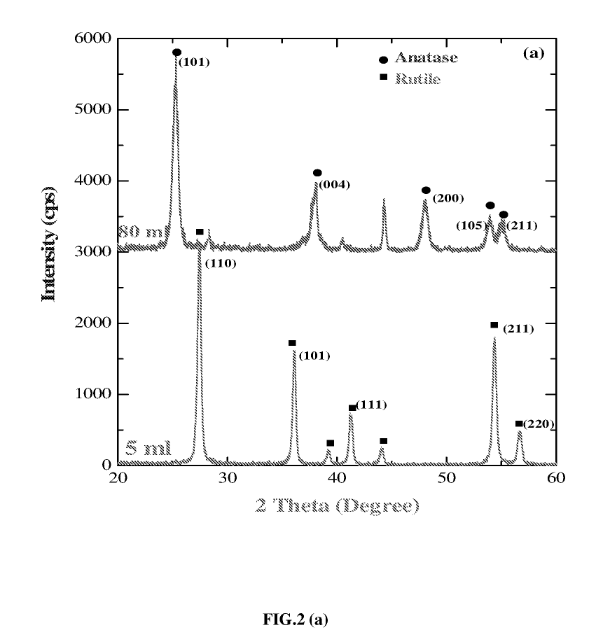

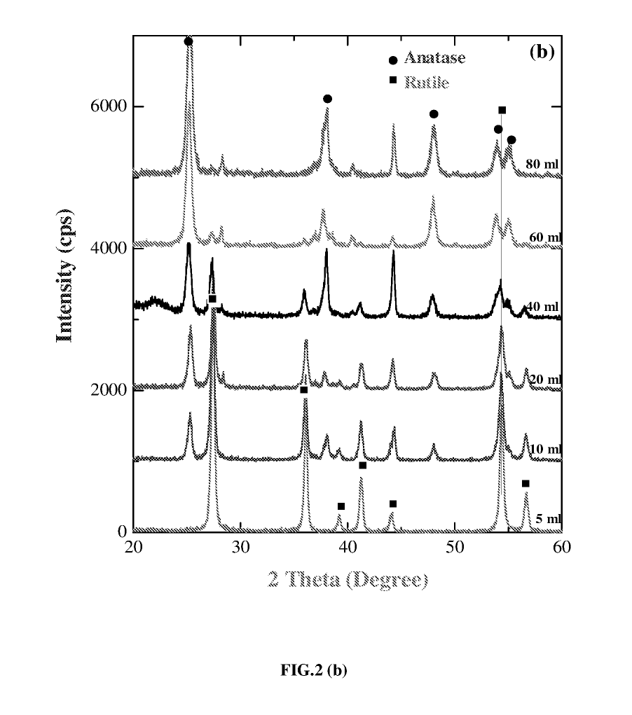

The diffraction pattern was recorded by XRD with Cu-Kα radiation (λ=1.540598 A°) as the excitation source. FIGS. 2 (a) and (b) show the XRD pattern of TiO₂ prepared with different amount of plant extracts. The peak at the 2 theta value of 25.4 and 27.5 corresponds to the anatase (101) and rutile (110) respectively. The weight fraction of the anatase found in the samples were calculated by comparing the XRD integrated intensities of (101) reflection of anatase and (110) reflection of rutile. The anatase (101) peak at 25.4 and the rutile (110) peak at 27.5 were analyzed using the following formula as per R. A. Spurr, H. Myers, Anal. Chem. 29 (1957) 760.

$$x = {( 1 + 0.8 \frac{{I}_{A}}{{I}_{R}} )}^{- 1}$$

where, x is the weight fraction of rutile in the powders, and IA and IR are the X-ray intensities of the anatase and rutile peaks, respectively.

Table 1 shows the weight % (wt. %) of anatase and rutile in the undoped TiO₂ produced by using different preparation conditions. Crystalline sizes for anatase and rutile were estimated from the Debye-Scherrer formula using the (101) peak of anatase and the (110) peak of rutile, respectively. The size of anatase particle vaired from 14-18 nm where as the rutile particles size varied from 71-33 nm.

TABLE 1

| | Anatase | Rutile |
|---|---|---|
| Volume of flower extract | wt % | wt % |
| 5 ml | 0 | 100 |
| 10 ml | 20.14 | 79.86 |
| 20 ml | 31.21 | 68.79 |
| 40 ml | 50.12 | 49.88 |
| 60 ml | 86.00 | 14.00 |
| 80 ml | 100 | 0 |

XRD of the sample prepared with 5 ml of extract indicated that the sample was 100% rutile TiO₂ as shown in FIG. 2(a). The intensity of the anatase peak significantly increased while the rutile peak decreased when the flower extract increased from 10 to 60 ml as shown in FIG. 2(b). For 80 ml of plant extract, the TiO₂ comprised of 100% anatase. From XRD it was confirmed that the anatase and rutile weight percentages have been changed from 100% rutile TiO₂ to 100% anatase TiO₂ depending on the quantity of the flower extract.

For Ag doped TiO₂ as Ag doping increases two new peaks at about 37.8 and 44.2 were observed, which corresponds to (111) and (200) peaks for Ag. In the Ni doped samples the Ni (111) peak was observed at 44.3° and intensity increased as the doping concentration increases.

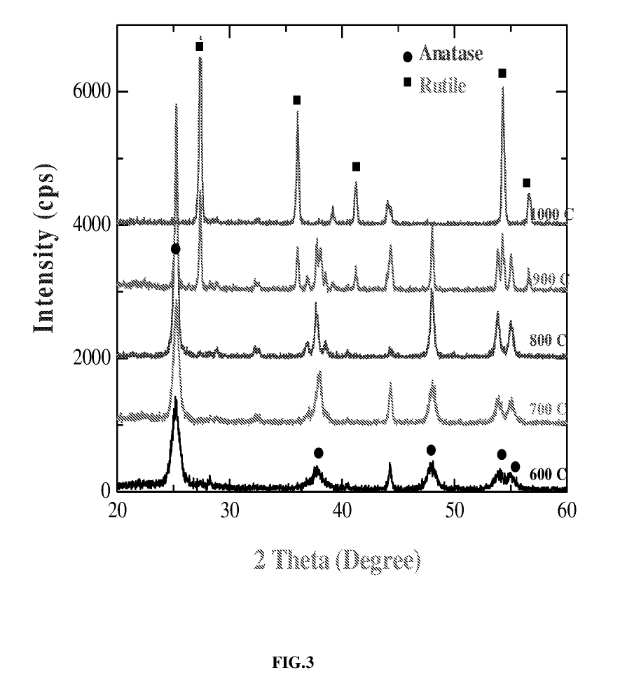

In order to investigate the influences of the annealing process of TiO₂ the 100% anatase TiO₂ was annealed at 600° C., 700° C., 800° C., 900° C. and 1000° C. for 2 hrs. The XRD of the 100% anatase annealed at different temperature is shown in FIG. 3. The intensity of the rutile peak significantly increased while that of the anatase peak decreased as the temperature increased beyond 800° C. As shown in the FIG. 3 the annealing at 900° C. still shows the anatase peak at the 2 theta value of 25.4 indicating the presence of anatase TiO₂. For annealing at 1000° C. the anatase peak disappeared and rutile appeared as a major phase. This transformation is an irreversible metastable to stable phase transition. Anatase to rutile transformation usually occurs at a temperature of 600° C. to 700° C. But the TiO₂ nanoparticles prepared by the prposed green synthesis method are more stable and the transition took place only after 800° C. and even at 900° C. the anatase phase remains.

### 5.2. Raman Spectroscopy

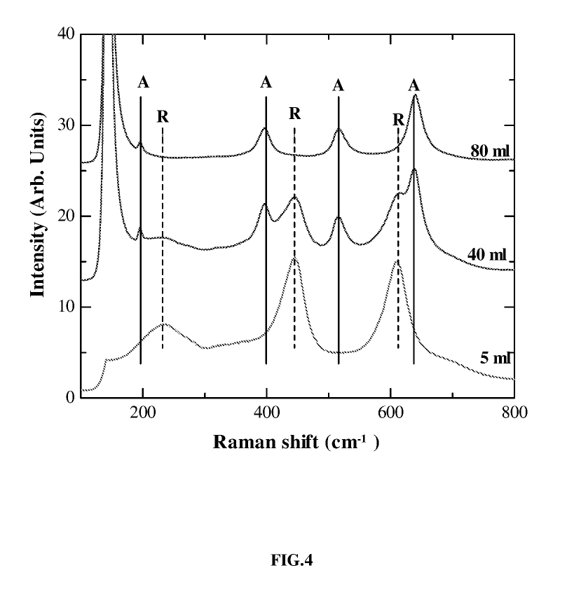

FIG. 4. shows the Raman spectra obtained with different dosage of flower extract. According to factor group analysis anatase phase consists of six and rutile phase consists of five Raman active modes. (i.e. anatase—144 cm-1, 197 cm-1, 399 cm-1, 513 cm-1 and 639 cm-1; rutile—144 cm-1, 446 cm-1, 612 cm-1 and 827 cm-1.) FIG. 4 shows a strong peak at 446 and 612 cm-1 for 5 ml of extract which indicated 100% rutile for 5 ml of extract. For 40 ml of extract the peaks for anatase and rutile were observed. For the sample prepared by using 80 ml of extract only the anatase peaks were observed at 399 cm-1, 513 cm-1 and 639 cm-1.

### 5.3. High Resolution Transmission Electron Microscope (HR-TEM) Analysis

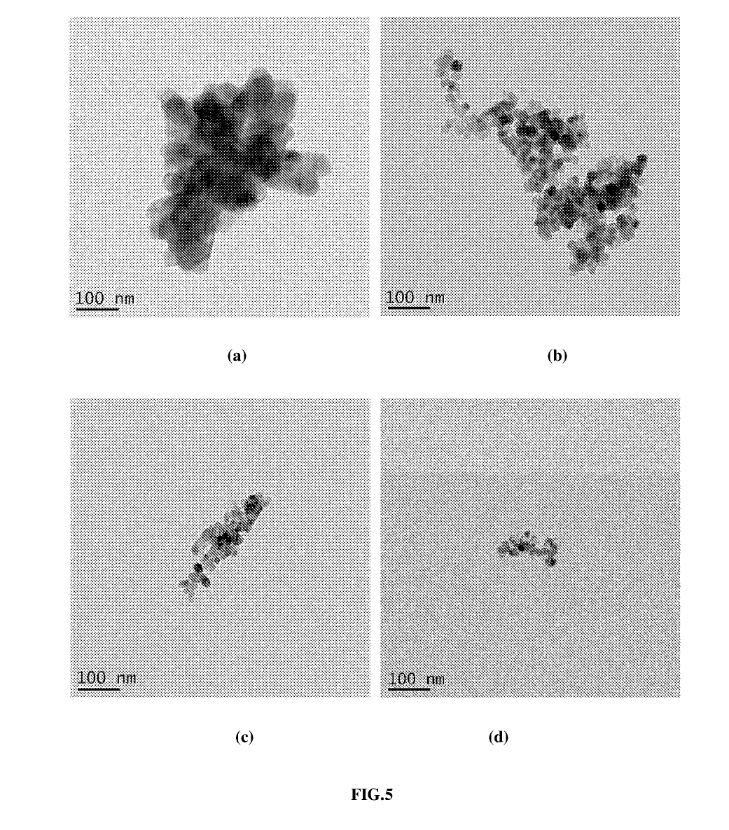

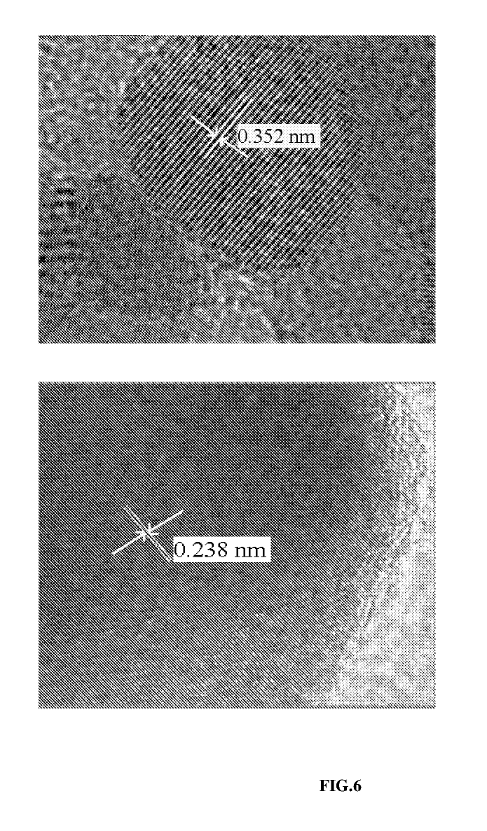

The samples were analyzed by HR-TEM to determine and compare the size and morphology of the particles prepared from various conditions. FIG. 5 shows the TEM image of TiO₂ nanoparticles prepared at different temperatures and volume of flower extracts. FIGS. 5 (a) and (b) show the TiO₂ nanoparticles prepared at 50° C. with 5 ml and 40 ml of flower extract. It is clear that the particle size has been greatly reduced to around 20 nm when increase the flower extract. FIGS. 5 (c) and (d) show TEM image of TiO₂ prepared at 70° C. and 90° C. with 40 ml of flower extract respectively. It is clear that the aggregation/aggloramation has reduced when prepared at high temperatures. FIG. 6 (a) shows the HR-TEM image of anatase (101) with spacing of 0.352 nm and (b) shows the HR-TEM image of rutile (004) phase with spacing of 0.238 nm.

### 5.4. Hr-Tem of Metals Doped TiO₂ Nanoparticles

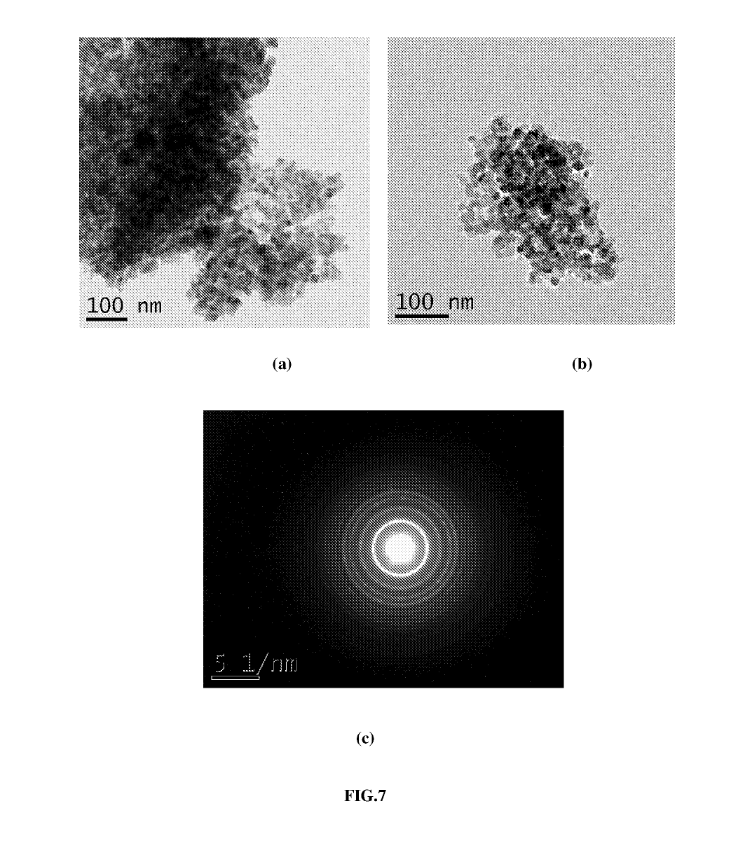

FIGS. 7 (a) and (b) show the TEM image of Ag doped and Ni doped TiO₂ nanoparticles respectively prepared at 50° C. with 40 ml of flower extract. FIG. 7 (c) shows the Selected Area Electron Diffraction (SAED) pattern of Ag doped TiO₂ nanopartilces. The smooth rings prove that the size uniformity of the nanoparticles is greatly improved when doped with Ag. The SAED studies are in good agreement with the XRD measurements. The anatase and rutile wt. % and crystalline size for different AgNO₃ precursors doping is shown in Table 2. As shown in the table the crystalline size of anatase and rutile TiO₂ has been reduced to 10-12 nm and 21-28 nm respectively when doped with Ag.

TABLE 2
Ag doping in TiO₂

| Wt. % of AgNO₃ | Anatase | Rutile | Anatase | Rutile |
|---|---|---|---|---|
| Precursor | wt. % | wt. % | size (nm) | size (nm) |
| 1% | 100 | 0 | 10.27 | — |
| 3% | 87.05 | 12.95 | 10.92 | 23.29 |
| 5% | 83.17 | 16.83 | 10.5 | — |
| 10% | 79.11 | 20.89 | 11.63 | 23.56 |
| 15% | 71.71 | 28.29 | 10.23 | 21.26 |
| 20% | 65.46 | 34.54 | 10.42 | 27.07 |

Table 3 shows the anatase and rutile wt. % and crystalline size for different doping of NiCl₂.6H₂O precursors.

TABLE 3
Ni doping in TiO₂

| Wt. % of NiCl₂•6H₂O | Anatase | Rutile | Anatase | Rutile |
|---|---|---|---|---|
| Precursor | wt. % | wt. % | size (nm) | size (nm) |
| 1% | 65.17 | 34.83 | 12.01 | 32.79 |
| 3% | 67.22 | 32.78 | 11.6 | 37.47 |
| 5% | 67.81 | 32.19 | 11.92 | 30.05 |
| 10% | 82.25 | 17.75 | 15.54 | 35.43 |
| 15% | 88.14 | 11.86 | 16.22 | 41.41 |
| 20% | 82.64 | 17.36 | 14.75 | 42.1 |

### 5.5. High Resolution Scanning Electron Microscopy (HR-SEM)

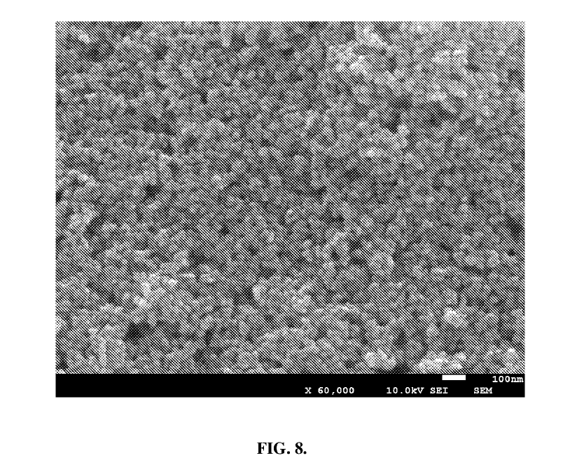

FIG. 8 shows the HR-SEM image of a nanoparticles film on FTO glass substrate. This shows that the nanoparticles are quit uniform and the size is around 20 nm. A close look reveals that the degree of agglomeration of TiO₂ nanoparticles are less.

### 5.6. Electron Dispersive X-Ray Analysis (EDX) and Electron Probe Micro-Analyzer (EPMA)

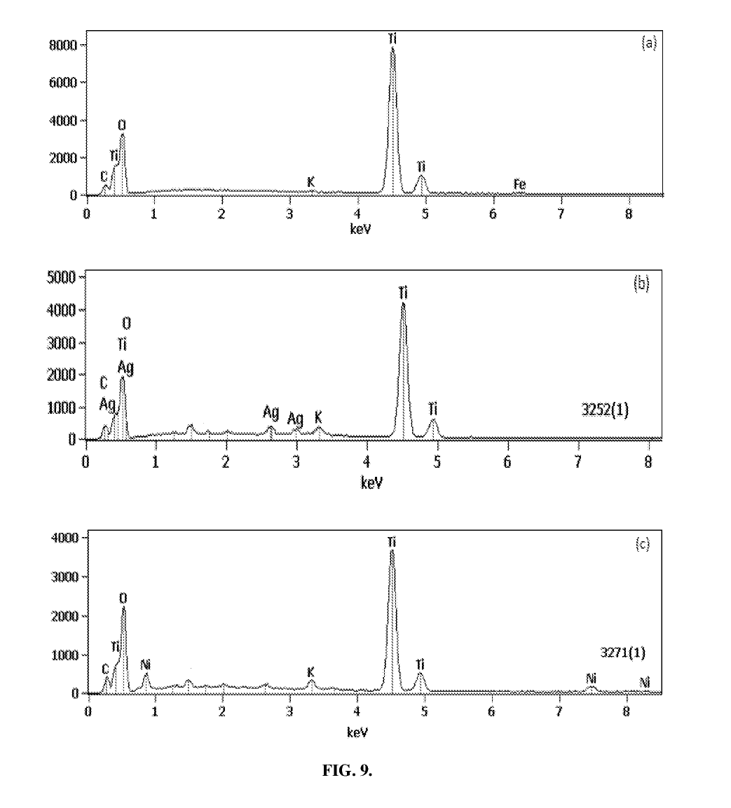

In order to confirm the chemical composition of the synthesized powders, the undoped, Ag doped and Ni doped samples were examined by EDX analysis. The EDX of the (a) undoped (b) Ag doped and (c) Ni doped TiO₂ nanoparticles are shown in FIG. 9. The atomic percentage of titanium and oxygen was 33% and 64.5% respectively for undoped TiO₂ sample. The atomic percentage of dopants Ag and Ni was determined as 1.12% and 4.41% respectively by EDX. A small amount of carbon (C) was also found.

From EPMA the Ti and O atomic ratio was 32.69% and 64.74% respectively. Also 2.07% of C was observed. These results show the presence of TiO₂ with very less impurities.

### 5.7. X-Ray Photoelectron Spectroscopy (XPS)

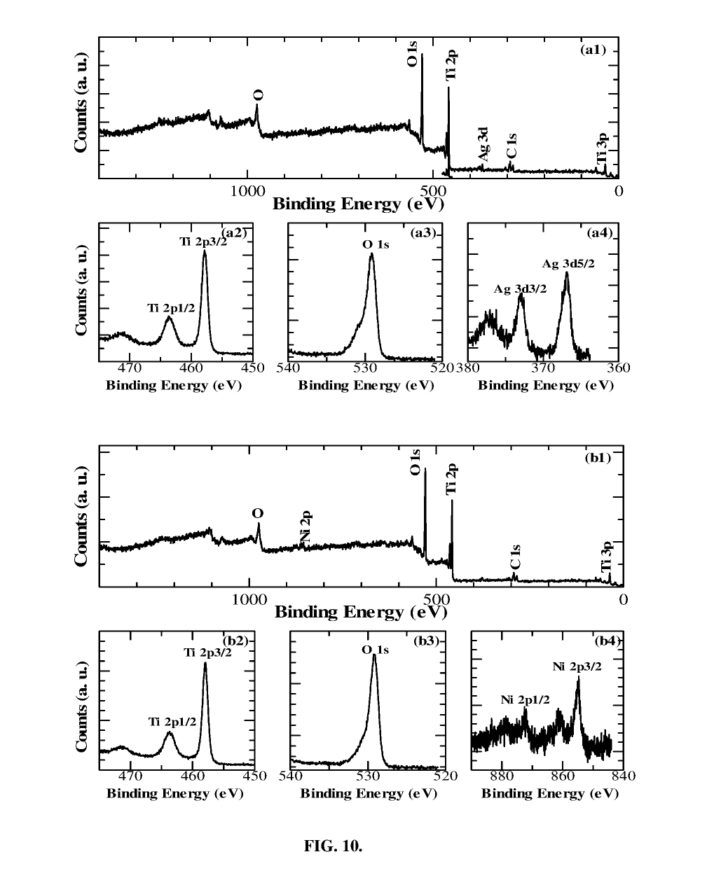

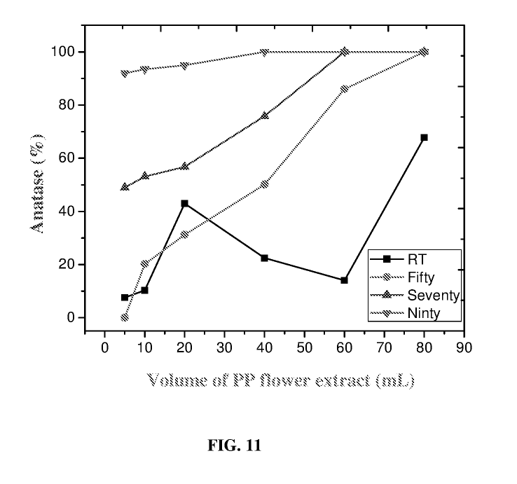

The XPS survey spectrum reveals the peak of Ti, O, C and dopand materials. FIGS. 10 (a) and (b) show the XPS spectrum of Ag doped and Ni doped TiO₂ nanoparticles respectively. From XPS spectrum the binding energies of Ti 2p and O 1s of TiO₂ nanoparticles are 458 eV and 529.2 eV respectively. Ti 2p spectrum consists of the distinct Ti 2p_{1/2} and Ti 2p_{3/2} photoelectron signals that are located at 463.7 eV and 458 eV, respectively. Both Ti 2p signals are highly symmetric and no shoulders were observed on the lower energy sides of Ti 2p_{3/2} signal, which indicate that the TiO₂ nanocrystals are stoichiometric and the concentration of lattice defects is extremely low. In addition a weak C 1s peak at 284.5 eV is observed. The C peak might be due to ambient air contamination and burning of flower at high temperature. The presence of Ag was confirmed from Ag 3d_{5/2} peak at 367 eV and 3d_{3/2} peak at 373 eV. The Ni 2p_{3/2} and 2p_{1/2} were observed at 855 eV and 872 eV respective for Ni doped TiO₂ sample.

### 5.8. Preparion and Evaluation of Dye Sensitized Solar Cells (DSSCs)

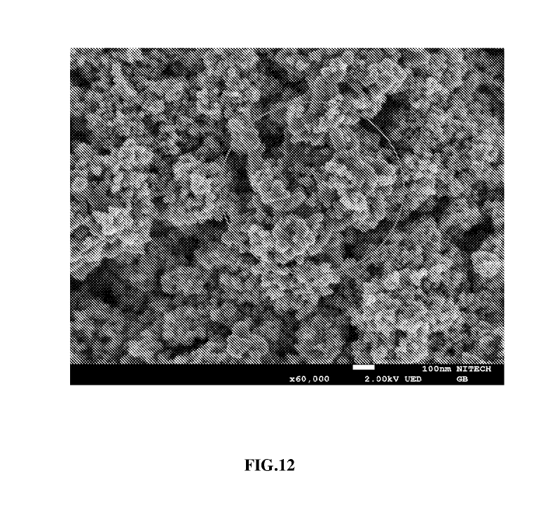

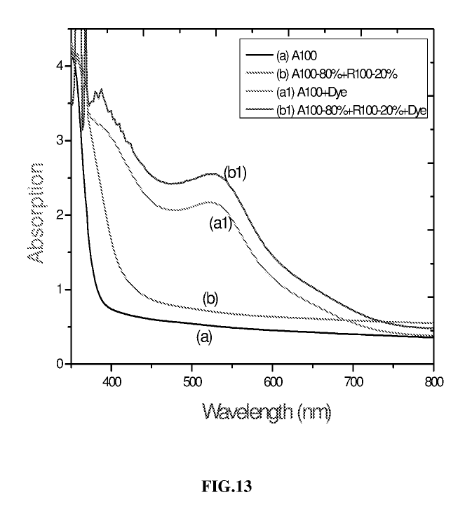

The TiO₂ Nanoparticles are coated on conducting FTO (fluorine doped tin oxide) substrate by Doctor blade method (removes the excess ink from the smooth non-engraved portion of the image carrier first used by Mann George in 1952) and dye sensitized solar cells (DSSCs) were fabricated with 100% anatase TiO2, anatase and rutile mixed TiO₂. FIG. 12 shows the FE-SEM image of rutile and anatase mixed nanoparicles coated on FTO substrates. As shown in the circle the rutile particles are visible on the surface. The influence of rutile content on dye absorption was investigated by measuring optical absorption spectra of the dye-sensitized films. FIG. 13 shows the UV-visble absorption of (a) A100 (b) 80 wt % of A100 and 20 wt % of R100 without and (a1), (b1) with dye loading respectively. The peaks observed near 530 nm corresponds to the characteristic absorption of N719 dye. As shown in the figure the absorption increases when we mix the 20 wt % of rutile in anatase TiO₂ particles.

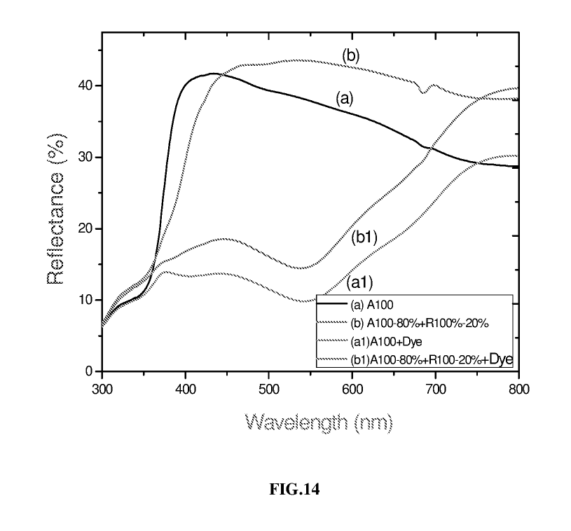

The adsorption enhancement should be related to the increase in light scattering owing to the presence of the rutile nanopartilces. The lightscattering property of the dye-free TiO₂ films and with dye loading were evaluated by diffuse reflectance spectroscopy. FIG. 14 shows the UV-Visible reflection of (a) A100 (b) 80 wt % of A100 and 20 wt % of R100 without and (a1), (b1) with dye loading. The anatase film exhibits poor light-scattering capability in the visible and near-infrared region. When the 20 wt % of rutile mixed in anatase the reflectance of the TiO₂ composite films increases, indicating improved light-scattering capability.

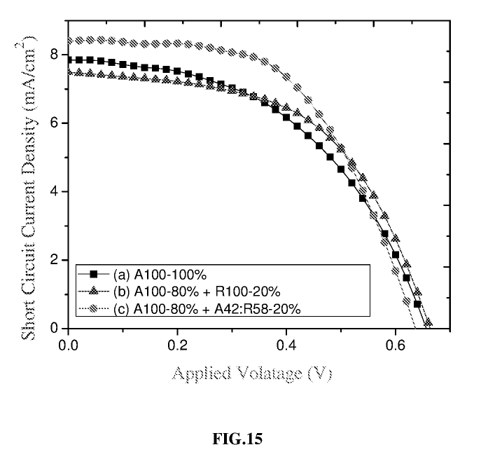

The current-density-voltage (J-V) characteristics for the masked DSSCs with TiO₂ composite films as photoanodes are presented in FIG. 15, and the corresponding cell parameters are summarized in table 4. The overall energy conversion efficiency (η) of the DSSCs is given by Efficiency (η)=(J_{sc}×V_{OC}×FF)/Pᵢₙ, where J_{sc}, V_{OC}, and FF stand for short-circuit current density, open-circuit voltage, and fill factor, respectively. Incident light intensity Pᵢₙ used here is 100 mW cm⁻². By adding the 20 wt % of mixed TiO₂ A42:R58, Jsc increases from 7.84 to 8.397 mA cm⁻², resulting in a corresponding enhancement of η from 2.48 to 2.95%. As shown in table 4, the conversion efficiency for the DSSC based on the TiO₂ film with 20 wt % of R100 and A42:R58 is enhanced by 8% and 19% as compared to those of the DSSCs prepared from pure anatase nanoparticles, respectively. It is clear that the DSSC with the mixed nanoparticles resulted in higher efficiency. Mixed aggregated Rutile phase with anatase phase TiO₂ possess several advantages for high performance of DSSCs, including the light scattering by the micronized TiO₂. Also, the Fill Factor (FF) of the DSSC with mixed TiO₂ has increased by 14.6% compare the pure anatase structure. The fill factor can assume values between 0 and less than 1 and is defined by the ratio of the maximum power (Pmax) of the solar cell per unit area divided by the Voc and Jsc. Anything that changes charge transport or charge recombination can greatly affect the FF.

TABLE 4

| | Isc | Voc | | Effi. |
|---|---|---|---|---|
| TiO2 Nanoparticle | (A/cm2) | (V) | FF | (%) |
| A100 | 7.8425 | 0.6565 | 0.4822 | 2.4827 |
| A100-80% + R100-20% | 7.4913 | 0.6635 | 0.5418 | 2.6933 |
| A100-80% + A42:R58-20% | 8.3975 | 0.6366 | 0.5530 | 2.9560 |

The present invention is advantageous in that it provides a simple and cost effective process for the production of TiO₂ with desired ratio of anatase and rutile nanoparticles without and with metallic dopants. The process has an additional advantage that it is a green synthesis method which is eco friendly, since it minimizes the use of chemical substances.

1. A process for the production of titanium dioxide (TiO₂) nanoparticles with desired ratio of anatase phase and rutile phase, the method comprising
(a) reacting titanium trichloride (TiCl₃) solution with a flower extract
(b) drying the reaction mixture obtained in step (a) at high temperature to powder form and
(c) calcination of the powder obtained in step (b) at high temperatures.

2. The process according to claim 1, wherein the process comprises doping TiO₂ nanoparticles with water soluble metal precursor.

3. The process according to claim 1 wherein step (a) comprises reacting titanium trichloride (TiCl₃) solution and a water soluble metal precursor with a flower extract.

4. The process according to claim 3, wherein the water soluble metal precursor is a water soluble metal precursor of a metal selected from the group consisting of Ag, Ni, Zn, Cr, Ge, Mo, Ru, Rh, Sn, W, Sr, Al, Si, Mn, Fe, Au, Pt, Co, V, Cu and Pd.

5. The process according to claim 3, wherein the water soluble metal precursor is present in an amount of 1 to 30% by weight.

6. The process according to claim 1, wherein TiCl₃ in step (a) is 0.1%-30% aqueous solution of TiCl₃.

7. The process according to claim 1 wherein the flower extract is Peltophorum pterocarpum flower extract.

8. The process according to claim 1, wherein the flower extract is prepared by heating the flowers in double distilled deionized water at a temperature of 40° C.-95° C.

9. The process according to claim 1, wherein reacting in step (a) is done with stirring at a speed of 5 to 100 rpm, preferably 20-40 rpm, more preferably 30 rpm.

10. The process according to claim 1, wherein the temperature in step (a) is 40° C. to 200° C.; preferably 50-90° C.

11. The process according to claim 1, wherein step (a) is operated with a residence time of 60-360 minutes; preferably 120-180 minutes; more preferably 120 minutes.

12. The process according to claim 1, wherein drying in step (b) is carried out at a temperature of 40° C.-110° C.

13. The process according to claim 1, wherein the temperature of calcinations in step (c) is 300° C.-800° C.; preferably 400-650° C.; more preferably 600° C.

14. The process according to claim 1, wherein calcinations is carried out for a duration of from 60 to 300 minutes; preferably 150-210 minutes; more preferably 180 minutes.

15. The process according to claim 1, wherein the ratio of anatase to rutile in TiO₂ is 0:100% to 100:0% by weight.

16. A solar cell comprising the mixed (TiO₂) nanoparticles produced by the process of claim 1.

17. The solar cell as claimed in claim 16 wherein it is a dye sensitized solar cell (DSSC) fabricated with mixed nanoparticles of TiO₂.

18. The DSSC prepared with mixed TiO₂ as claimed in claim 17 wherein it has high fill factor due to the changes in charge transport.

19. The process according to claim 1, wherein the flower extract is added in an amount of 5 ml to 30 ml.
